(19) United States
(12) Patent Application Publication
(10) Pub. No.: US 2006/0070695 A1
(43) Pub. Date: Apr. 6, 2006

(54) Method of selecting a binder for a chipsealing process based on its adhesion index

(76) Inventor: James Barnat, Wichita, KS (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 10/926,174

(22) Filed: Aug. 25, 2004

(51) Int. Cl. B32B 17/10

(52) U.S. Cl. 156/100

(57) ABSTRACT

A method of selecting a binder for a chipsealing process is provided. This method includes measuring the Adhesion Index of at least one binder and selecting a binder with a desirable Adhesion Index for the chipsealing process. The selected binder should have an Adhesion Index no greater than about 3.75 when calculated according to the most preferred method of the present invention. Preferably, the selected binder is applied to a surface and then aggregate is applied within the time parameters defined by the Adhesion Index of the binder to form a chipsealed surface. Preferably, substantially all of the aggregate bonds to the binder without the need for compacting the paved surface.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

The present invention relates to a method of paving a roadway. More specifically, this method includes choosing a bituminous binder for a chipsealing process based on its Adhesion Index.

Hot applied chipseals commonly are applied to pave or upgrade a roadway. However, one disadvantage with conventional chipseals is pervasive aggregate loss over time.

In an attempt to overcome excessive aggregate loss, aggregate has been precoated with bitumen to increase its adhesion in the chipsealing process. Many bitumen coatings will completely cover the aggregate material. One disadvantage with precoatings is that if too much bitumen is added, the aggregate will stick together and form clumps. Another disadvantage with precoating aggregate is that it is expensive due to the additional materials needed and because handling the precoated aggregate is costly.

Methods to increase the embedment of aggregate in the binder also have been tried. One such method involves applying a thicker layer of bitumen to improve adhesion. One disadvantage of such a method is that this creates additional expense.

Antistripping agents also have been added to bitumen to help the adhesion of aggregate to the bitumen. However, even when using such agents, aggregate loss is still problematic. Another disadvantage of using antistripping agents is that they are costly.

Typically, to ensure maximum adhesion, the chipsealed surface is compacted or rolled. One disadvantage with compaction is that it is an additional step in the paving process increasing the time and cost of the chipsealing process. Further, it requires additional equipment. Still further, even with precoated aggregate, antistripping agents, higher embedment of aggregate, and compaction, excessive aggregate loss still occurs.

In order to overcome these disadvantages, a method of chipsealing a road that provides better aggregate adhesion is desired. This method should provide a way to select a binder for the chipsealing process that has good adhesion.

### SUMMARY OF THE INVENTION

It is an object of the present invention to provide a better method for selecting a binder so that the binder's adhesion to aggregate is desirable and excessive aggregate is not lost when paving a surface.

The foregoing and other objects are achieved by the method of the present invention for selecting a binder for a chipsealing process. This method includes measuring the Adhesion Index of at least one binder and selecting a binder with a desirable Adhesion Index for the chipsealing process. The selected binder should have an Adhesion Index no greater than about 3.75, when calculated from 100 times the log₁₀ of the viscosity of the binder at the highest temperature the binder reaches after contact with the aggregate multiplied by the inverse of the binder's penetration value at 25° C. Preferably, the selected binder is applied to a surface and then aggregate is applied as defined by the Adhesion Index of the binder to form a chipsealed surface. Preferably, substantially all of the aggregate bonds to the binder without the need for compacting the paved surface.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a graph showing the relationship between the logarithm of the viscosity of a bitumen binder and the Sweep Test mass loss of the aggregate;

FIG. 2 is a graph showing the relationship between the logarithm of the viscosity of a bitumen binder and the Sweep Test mass loss of the aggregate;

FIG. 3 is a graph showing the relationship between the viscosity of four different bitumen samples, ranging from very soft to very hard, each at different potential aggregate application temperatures and the Sweep Test mass loss of the aggregate at those particular temperatures;

FIG. 4 is a graph showing the Adhesion Index of various bitumen binders versus the Sweep Test mass loss of aggregate applied to the corresponding binder; and

FIG. 5 is a graph showing the heat loss over time of hot bitumen as it cools after being applied on a surface.

### DETAILED DESCRIPTION OF PREFERRED EMBODIMENT

The method of the present invention relates to selecting a binder appropriate for a chipsealing process. This method includes determining the Adhesion Index of at least one binder at one temperature and preferably determining the Adhesion Indexes of multiple binders at multiple temperatures.

Adhesion Index (AI) is defined as a rheological property of the binder at the highest temperature it reaches after contact with the aggregate multiplied by a rheological property of the binder at a temperature relatively near its in-service temperature on the surface to which it is applied. The Theological properties of the binder that are measured should increase as the binder becomes stiffer. If the selected rheological property decreases as the binder becomes stiffer, then the inverse of that rheological property should be used in calculating a binder's Adhesion Index. Logarithms of the Theological properties that are measured may be taken in order to achieve a more linear relationship. The Adhesion Index is a unitless number and provides an index that predicts adhesive properties of the binder.

Preferably, the binder's Adhesion Index is calculated using viscosity and penetration value measurements. Most preferably, the binder's Adhesion Index is the log₁₀ of the viscosity (centipoise (cPs)) of the binder at the highest temperature it reaches after contact with the aggregate multiplied by the inverse of the binder's penetration value (decimillimeters (dmm)), and the resulting number is multiplied by 100. More specifically, most preferably, the binder's Adhesion Index is calculated according to the following equation:
AI=log₁₀(viscosity (cPs) at binder's highest temperature after aggregate contact)×(1/penetration value (dmm) at 25° C.)×100
The inverse of the binder's penetration value is used so that this rheological property increases as the stiffness of the binder being tested increases.

Typically, a hot binder is applied and its temperature decreases once it is applied to a surface, and upon aggregate application, its temperature continues to decrease. However, if hot aggregate is used, the binder's temperature may increase for a few seconds after aggregate application.

A binder's Adhesion Index varies depending upon its temperature. In order to determine the Adhesion Index of a binder at various temperatures, its viscosity is measured at various temperatures. The penetration of the bitumen binder is also measured relatively near its in-service temperature. The penetration value may be measured at any temperature below the softening point of the binder and above the glass transition temperature of the binder, such temperatures are considered near the in-service temperature. This typically is between about −30 and 50° C. Preferably, the penetration value is measured at a temperature of about 15-35° C. More preferably, it is measured at a temperature of about 25-30° C. Most preferably, the penetration of the bitumen is measured according to ASTM D5.

It is contemplated and included within the scope of the present invention that other Theological properties (i.e., shear modulus, melt index, toughness, dynamic shear modulus) could be measured to determine the Adhesion Index of the binder.

After the Adhesion Indexes of the tested binders are calculated, a binder is selected for the chipsealing process based on its Adhesion Index. The selected binder should have an Adhesion Index of no more than about 3.75 when calculated according to the most preferred method of the present invention in order to adhere about 80% of the aggregate applied thereto. Preferably, the selected binder has an Adhesion Index of no more than about 3.5 when measured as defined above. Most preferably, the selected binder has an Adhesion Index of no more than about 3.25 when measured as defined above. In many cases, the selected binder includes a polymer, modifier, and/or oil added to the bitumen. The ideal binder will have a low Adhesion Index while providing a high enough modulus to withstand high temperatures under traffic.

The selected binder is applied to a surface followed by aggregate being applied on the binder. Preferably, the binder and aggregate are applied using a single vehicle, which allows for more precise control of the time between application of the bitumen and aggregate. Preferably, they are applied in a continuous process. Preferably, the aggregate is applied within 10 seconds of the binder. More preferably, the aggregate is applied within 5 seconds of the binder. Most preferably, the aggregate is applied within 1 second of the binder. This shortens the time that the binder is allowed to cool and thus keeps the binder's Adhesion Index value lower. Preferably, the aggregate is applied when the binder has a temperature of at least about 80° C. More preferably, the aggregate is applied when the binder has a temperature of at least about 95° C. Most preferably, the aggregate is applied when the binder has a temperature of at least about 110° C. Alternatively, a cooler binder may be applied followed by the application of hot aggregate so as to raise the binder's temperature to at least about 80° C., preferably at least about 95° C., and most preferably at least about 110° C.

However, equipment alone cannot guarantee an acceptable Adhesion Index. Table 1 shows the Adhesion Index, which is calculated according to the most preferred method of the present invention, of three different commercially available hot applied chipseal binders at various application temperatures. Two of the examples shown in this table represent typical application times using multiple pieces of equipment, namely, applying aggregate about 15 or 30 seconds after binder is applied. It is less typical to apply aggregate within 10 seconds after the binder is applied, as done in the last example in Table 1, when using multiple pieces of equipment due to equipment logistics and safety concerns. A 150° C. storage temperature was used. An immediate temperature loss of 20° C. was used for the initial spray followed by standard enthalpy loss transferring to the substrate thereafter.

TABLE 1
Adhesion Index
(calculated according to most preferred
method of the present invention)

| Aggregate | | | | |
|---|---|---|---|---|
| Application Time | AC Temp | AC-15P | AC-15XP | AC 15-5TR |
| 30 seconds | 60° C. | 3.9 | 5.0 | 7.8 |
| 15 seconds | 75° C. | 3.5 | 4.6 | 7.0 |
| 10 seconds | 95° C. | 2.9 | 3.8 | 5.9 |

Table 2 details the Adhesion Index for the three chipseal binder samples as applied by a single piece of equipment using a synchronous process.

TABLE 2

| Synchronous | | Adhesion Index | | |
|---|---|---|---|---|
| Process | | (calculated according to most preferred | | |
| 1 second | | method of the present invention) | | |
| application | AC Temp | AC-15P | AC-15XP | AC15-5TR |
| | 130° C. | 2.1 | 2.8 | 4.5 |

While the Adhesion Index values shown in Table 2 are more desirable than most of the values shown in Table 1, all of the synchronous process Adhesion Index values do not meet the criteria of the present invention. Having a higher binder temperature at the time of aggregate application positively affects the binder's Adhesion Index, but it may not be sufficient to make an undesirable binder acceptable. Increased binder temperature alone is not the solution to improve binder/aggregate adhesion. Tables 1 and 2 illustrate that both binder formulation and application conditions play important roles in providing binders with desirable Adhesion Indexes. As shown in Tables 1 and 2, AC-15P provides the best Adhesion Index numbers. Meanwhile, the data in these tables shows that AC15-5TR may never meet the Adhesion Index criteria of the present invention. By using the method of the present invention to formulate a desirable binder and determine an acceptable aggregate application time, superior chipsealed roads can be created.

Preferably, it is not necessary to compact the aggregate and binder in the chipsealing process of the present invention because there will be desirable adhesion without a compacting step. It is desirable to test the adhesion of the selected binder with the aggregate in a laboratory setting before chipsealing a chosen surface.

Preferably, a Sweep Test is used to measure the bonding force between the hot applied bituminous binder and the aggregate. As bonding strength increases, the Sweep Test mass loss will decrease. The importance of this invention can be seen in adhesive failure rates as established by the Sweep Test. In this test, a chipseal specimen is physically abraded. More specifically, a constant force is imparted on the chipsealed surface in an effort to dislodge aggregate. The Sweep Test is performed below the softening point of the binder and above the glass transition temperature. This typically is between about −30° C. and 50° C. Preferably, the Sweep Test is performed at a temperature of about 15-35° C. More preferably, it is performed at a temperature of about 25-30° C. Most preferably, the Sweep Test is performed at or near the temperature that penetration is measured.

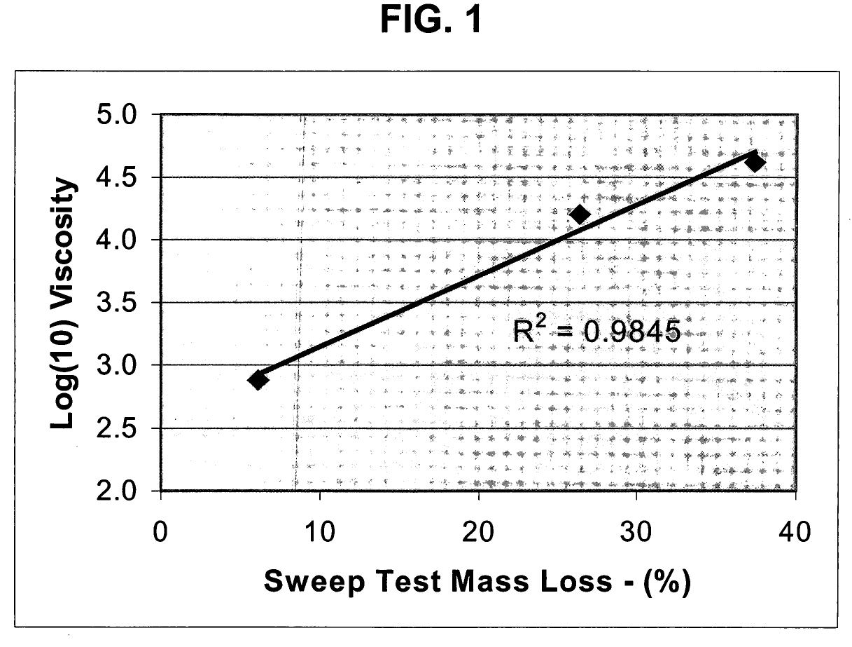

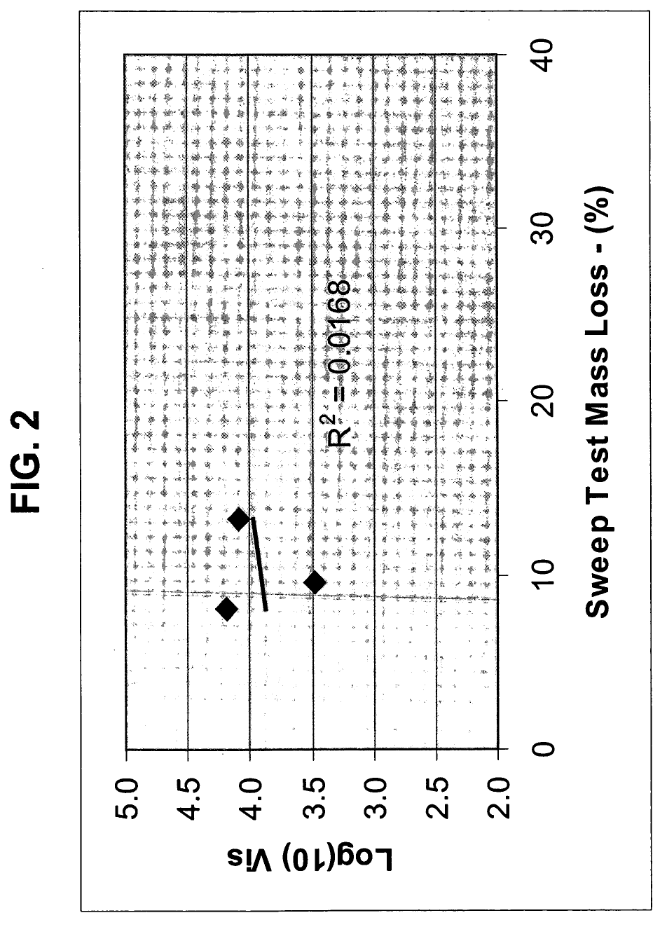

Viscosity alone is not necessarily an adequate predictor of adhesion or Sweep Test mass loss, as evidenced by FIGS. 1-3. FIG. 1 shows the relationships between viscosity and Sweep Test mass loss for a particular binder at various possible aggregate application temperatures. FIG. 2 shows the same relationship for a different binder but shows no correlation between viscosity and Sweep Test mass loss. FIG. 1 shows that as the viscosity increases, the bonding force weakens detailed by higher Sweep Test mass loss, but this relationship does not exist for the binder tested in FIG. 2. Thus, FIGS. 1 and 2 show that a bitumen's viscosity at the time of aggregate application cannot be used exclusively as a clear indicator of adhesion.

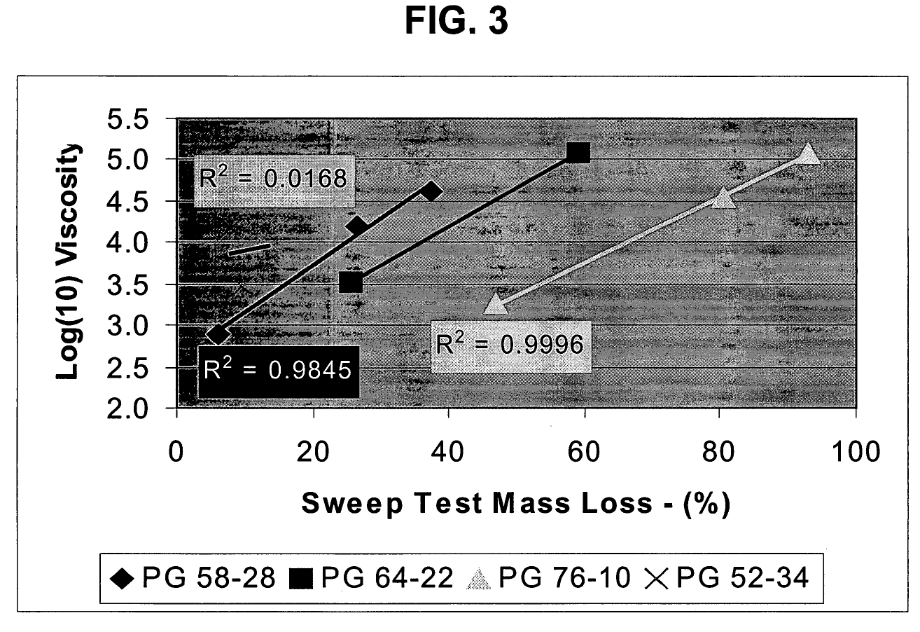

FIG. 3 shows the same relationship as graphed in FIGS. 1 and 2 for four samples of bitumen, ranging from very soft to very hard, each at different temperatures. While three of the four binders show a consistent relationship between the viscosity of the bitumen at various temperatures as aggregate is applied and the Sweep Test mass loss, there is no predictable relationship between viscosity and Sweep Test mass loss among the different binders. This again shows that a bitumen's viscosity at the time of aggregate application is not a clear indicator of adhesion properties.

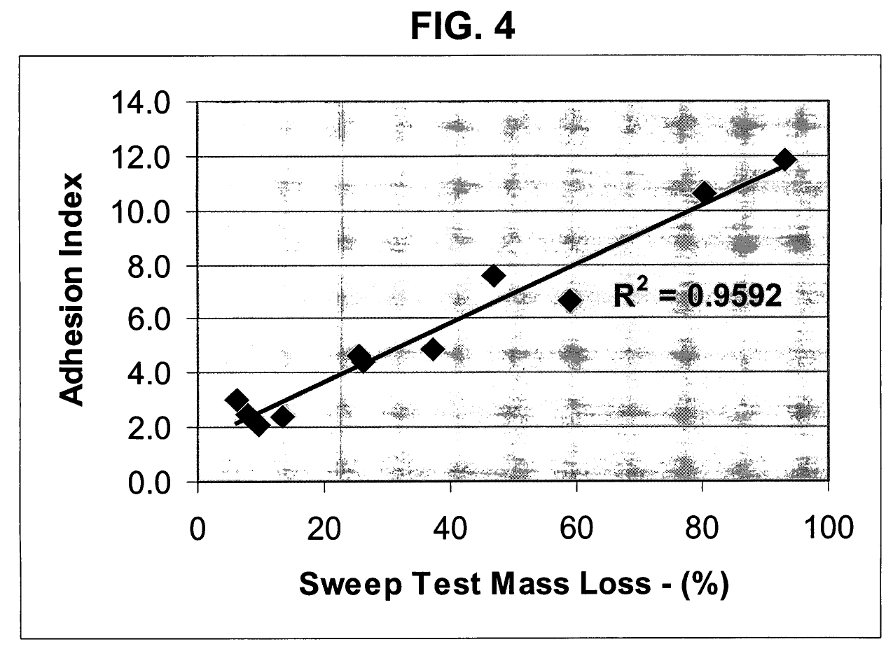

In contrast, a binder's Adhesion Index shows a strong correlation with the Sweep Test mass loss of a surface that is chipsealed with the binder. As seen in FIG. 4, the Adhesion Indexes were calculated according to the most preferred method of the present invention for four sources of bitumen, ranging from very soft to very hard, each at various temperatures. This data shows that a binder's Adhesion Index has a strong degree of accuracy in predicting Sweep Test mass loss, as demonstrated by an R² of 0.96 in the graph of FIG. 4. FIG. 4 shows a direct link between the Adhesion Index and the Sweep Test mass loss for a variety of types of bitumen.

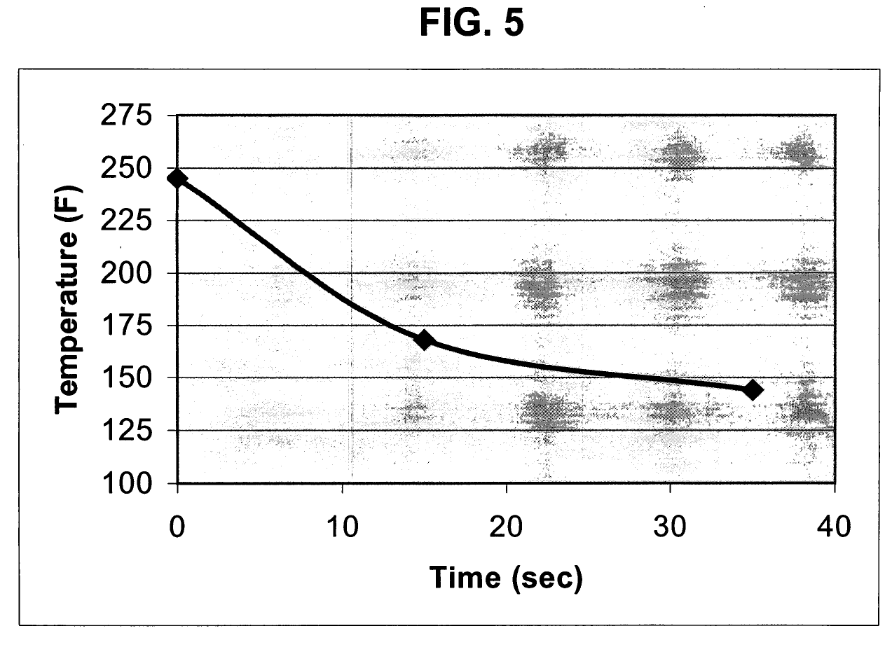

In the chipsealing process, the hot bitumen binder cools at a very high rate with the majority of its heat loss taking place in the first 10 seconds after application, as seen in FIG. 5. This is why the Adhesion Index of the binder is affected significantly by the time period between when the binder is applied and when the aggregate is applied. Nevertheless, as discussed previously, binder temperature alone may not be sufficient to make an undesirable binder acceptable.

At least about 1500 square meters should be paved while the Adhesion Index of the binder remains no greater than about 3.75, when calculated according to the most preferred method of the present invention. Preferably, at least about 3000 square meters are paved while the Adhesion Index of the binder remains no greater than about 3.75, when calculated according to the most preferred method of the present invention. More preferably, at least about 6000 square meters are paved while the Adhesion Index of the binder remains no greater than about 3.75, when calculated according to the most preferred method of the present invention. Most preferably, the Adhesion Index of said binder remains no greater than about 3.75 for the entire paving process. Substantially all of the aggregate should bond to the binder when the process of the present invention is followed. Preferably, at least about 80% of the aggregate bonds to the binder. Most preferably, at least about 90% of the aggregate bonds to the binder.

Using the method of selecting a binder of the present invention, the use of unnecessarily high bitumen embedment levels, pre-coated aggregate, anti-stripping agents, and/or compaction are not necessary to ensure aggregate adhesion. Further, the present invention provides a way to monitor and control the quality of the process in the field. Nevertheless, the method of the present invention can be used even when using high embedment levels, pre-coated aggregate, anti-stripping agents or compaction.

From the foregoing it will be seen that this invention is one well adapted to attain all ends and objectives hereinabove set forth, together with the other advantages which are obvious and which are inherent to the invention.

Since many possible embodiments may be made of the invention without departing from the scope thereof, it is to be understood that all matters herein set forth or shown in the accompanying figures are to be interpreted as illustrative, and not in a limiting sense. The examples discussed herein are not meant in any way to limit the scope of the present invention.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

I claim:

1. A method of selecting a binder for a chipsealing process, comprising:
providing at least one binder;
determining Adhesion Index of said at least one binder; and
selecting a binder for said chipsealing process after determining said Adhesion Index and based on said Adhesion Index of said at least one binder.

2. The method of claim 1 wherein said selected binder has an Adhesion Index no greater than about 3.75, when calculated from 100 times the log₁₀ of viscosity (centipoises) of said binder at said binder's highest temperature reached after contact with aggregate multiplied by the inverse of said binder's penetration value (decimillimeters) at 25° C.

3. The method of claim 1 wherein said selected binder has an Adhesion Index no greater than about 3.5, when calculated from 100 times the log₁₀ of viscosity (centipoises) of said binder at said binder's highest temperature reached after contact with aggregate multiplied by the inverse of said binder's penetration value (decimillimeters) at 25° C.

4. The method of claim 2, further comprising:
performing a Sweep Test to verify said at least one binder's adhesion before selecting said binder for said chipsealing process.

5. The method of claim 2, further comprising:
applying said selected binder to a surface; and
applying aggregate to said surface after applying said binder to form a chipsealed surface.

6. The method of claim 5 wherein said aggregate is in contact with said binder at a temperature of at least about 80° C.

7. The method of claim 5 wherein said aggregate is in contact with said binder at a temperature of at least about 95° C.

8. The method of claim 5 wherein said aggregate is in contact with said binder at a temperature of at least about 110° C.

9. The method of claim 5 wherein said binder and said aggregate are applied to said surface using a single piece of equipment.

10. The method of claim 9 wherein said application of binder and aggregate is a substantially continuous synchronous process.

11. The method of claim 10 wherein at least about 1500 square meters of a chipsealed surface are formed while said selected binder's Adhesion Index substantially remains no greater than about 3.75.

12. The method of claim 10 wherein at least about 3000 square meters of a chipsealed surface are formed while said selected binder's Adhesion Index substantially remains no greater than about 3.75.

13. The method of claim 10 wherein at least about 6000 square meters of a chipsealed surface are formed while said selected binder's Adhesion Index substantially remains no greater than about 3.75.

14. The method of claim 5 wherein said chipsealed surface is not compacted with a roller.

15. The method of claim 5 wherein said aggregate is distributed on said surface within about 5 seconds of when said binder is applied.

16. The method of claim 5 wherein said aggregate is distributed on said surface within about one second of when said binder is applied.

17. The method of claim 5 wherein said selected binder is comprised of asphalt and polymer.

18. A method of paving a surface, comprising:
applying an asphalt binder to said surface; and
distributing aggregate on said asphalt binder in such a manner that the Adhesion Index of said binder substantially remains no greater than about 3.75, when calculated from 100 times the log₁₀ of viscosity (centipoises) of said binder at said binder's highest temperature reached after contact with said aggregate multiplied by the inverse of said binder's penetration value (decimillimeters) at 25° C., while paving said surface.

19. The method of claim 18 wherein said paved surface is not compacted with a roller.

20. The method of claim 18 wherein said aggregate is distributed on said asphalt binder while said binder's Adhesion Index substantially remains no greater than about 3.5.

21. The method of claim 18 wherein said aggregate is distributed on said asphalt binder while said binder's Adhesion Index substantially remains no greater than about 3.25.

22. The method of claim 18 wherein at least about 80% of said aggregate bonds to said binder.

23. The method of claim 18 wherein at least about 90% of said aggregate bonds to said binder.

24. The method of claim 18 wherein said aggregate is in contact with said binder at a temperature of at least about 80° C.

25. The method of claim 18 wherein said aggregate is in contact with said binder at a temperature of at least about 95° C.

26. The method of claim 18 wherein said aggregate is in contact with said binder at a temperature of at least about 110° C.

27. The method of claim 18 wherein said surface is at least about 1500 square meters.

28. The method of claim 18 wherein said surface is at least about 3000 square meters.

29. The method of claim 18 wherein said surface is at least about 6000 square meters.

30. The method of claim 18 wherein said binder's Adhesion Index is no greater than about 3.75 for the entire paving process.

31. The product of the method of claim 5.

32. The product of the method of claim 18.

33. A method of paving a surface, comprising:
applying an asphalt binder to said surface; and
distributing aggregate on said asphalt binder in such a manner that the Adhesion Index of said binder substantially remains no greater than about 3.75, when calculated from 100 times the log₁₀ of viscosity (centipoises) of said binder at said binder's highest temperature reached after contact with said aggregate multiplied by the inverse of said binder's penetration value (decimillimeters) at 25° C., while paving said surface,
wherein said aggregate is in contact with said binder at a temperature of at least about 80° C., said surface is at least about 6000 square meters, and said aggregate is distributed on said surface within about 5 seconds of when said binder is applied.

34. The method of claim 33 wherein said aggregate is distributed on said asphalt binder while said binder's Adhesion Index substantially remains no greater than about 3.5.

35. The method of claim 33 wherein said aggregate is distributed on said asphalt binder while said binder's Adhesion Index substantially remains no greater than about 3.25.
